(19) United States
(12) Patent Application Publication
(10) Pub. No.: US 2002/0172054 A1
(43) Pub. Date: Nov. 21, 2002

(54) Boarding device with a light emitting device

(76) Inventor: Abraham R-K Teng, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 09/858,516

(22) Filed: May 17, 2001

(51) Int. Cl. B60Q 1/24

(52) U.S. Cl. 362/495; 362/481; 362/545; 362/517; 362/241

(57) ABSTRACT

A boarding device for a vehicle has an upper surface, and a lower surface. A step area is defined in the upper surface, and a light emitting device with corresponding control circuitry is set in a recess of the bottom side. The light emitting device provides illumination for the step area, so as to make boarding the vehicle more safe and convenient.

### BACKGROUND OF THE INVENTION

1. Field of the Invention

The present invention relates to boarding devices for motor vehicles, and more particularly, the present invention describes a boarding device that uses a light emitting device to illuminate a surface of the boarding device.

2. Description of the Prior Art

People use motor vehicles, such as automobiles, motorcycles, and metro buses, every day. As a result, many advances have been made in the field of motor vehicles. Instead of using metal wheels, most motor vehicles today have rubber tires. Cranks no longer need to be turned to start a motor, but instead a simple turn of a small metal key starts the motor. Another improvement made for motor vehicles was the advent of adding footpads below doors, which both drivers and passengers use to enter the vehicle.

Please refer to FIG. 1, which illustrates a prior art footpad 30. The footpad 30 is mounted under a door frame 22 of a truck 20 for assisting a person to get into the truck 20. The footpad 30 comprises a bottom side 31, a top side 32, and a connector 33 for connecting with the door frame 22 of the truck 20. Users are allowed to step on the top side 32 of the footpad 30 to board the truck 20. As the footpad 30 is set near or at a midpoint between the bottom of the door and the ground, the users do not need to overstretch or overexert their leg when boarding the truck 20. It is therefore convenient for users.

However, one small problem occurs when using the footpad 30. In the night, the footpad 30 (no longer visible) has changed from helpful device to harmful obstacle. It should be obvious that the lack of visibility is not limited to night time, but can also occur when a pattern of a background of the footpad 30 appears very similar to the actual surface of the footpad 30. When attempting to board the truck 20, users must very carefully use their leg and their sense of touch to discern a position of the footpad 30. This can be a time-consuming, or even a painful process.

### SUMMARY OF THE INVENTION

It is therefore an objective of the present invention to provide a boarding device, used in a motor vehicle, that uses a light emitting device (LED) to increase a visibility of the boarding device, so that a user can avoid shin and foot injuries when boarding the motor vehicle, and can save precious seconds wasted searching for the boarding device.

Briefly, the present invention is a boarding device that comprises a flat upper surface and a lower surface. The upper surface has a step area at a center portion for a person to step on. The lower surface has a recess used for installing a light emitting device that increases visibility of the step area.

It is an advantage of the present invention that the step area has greater visibility, which leads to fewer injuries and saves time in boarding the motor vehicle.

These and other objectives of the present invention will no doubt become obvious to those of ordinary skill in the art after having read the following detailed description of the preferred embodiment that is illustrated in the various figures and drawings.

### BRIEF DESCRIPTION OF THE DRAWINGS

FIG. 1 is a diagram of a prior art footpad mounted on a truck.

FIG. 2 is a diagram of a footpad, according to the present invention.

FIG. 3 is a diagram of a second embodiment footpad, according to the present invention.

FIG. 4 is a diagram of a third embodiment footpad, according to the present invention.

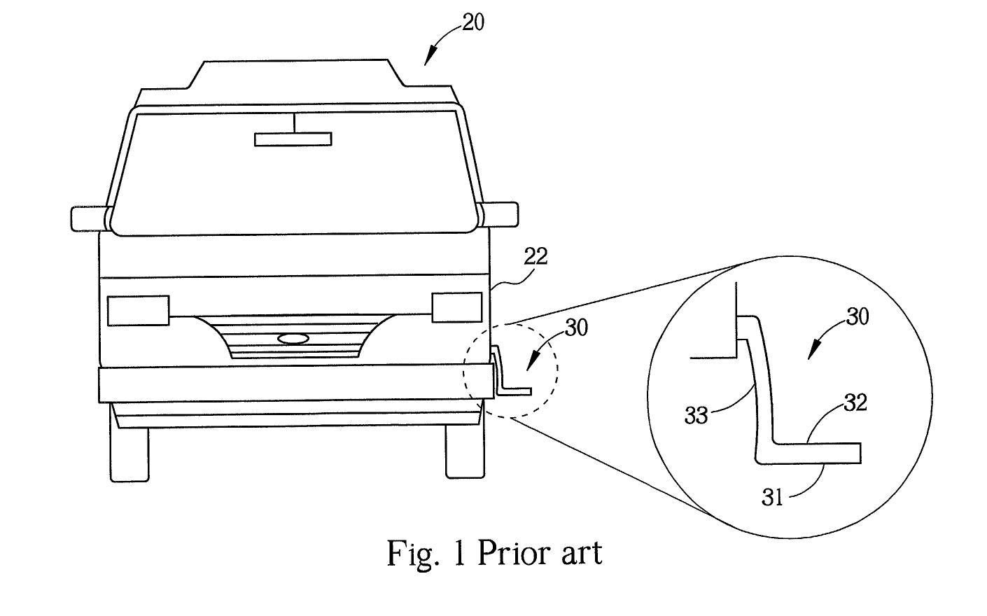

### DETAILED DESCRIPTION OF THE PREFERRED EMBODIMENT

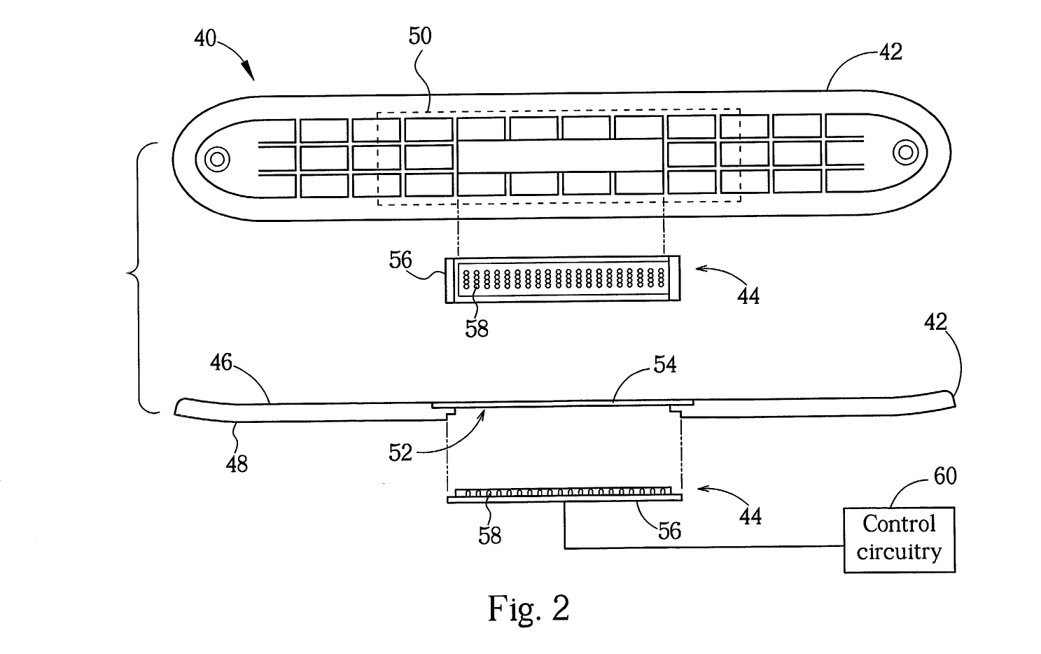

Please refer to FIG. 2, which is a diagram of a footpad 40 acting as a boarding device according to the present invention. The footpad 40 is mounted on a car having a door frame (not shown), and the foot pad 40 is positioned under the door frame of the car for assisting the person to get into the car.

As shown in FIG. 2, the footpad 40 comprises a step board 42 and a light emitting device 44. The step board 42 has a flat upper surface 46, and a lower surface 48. The upper surface 46 comprises a step area 50 near its center portion for a user to step on. The lower surface 48 comprises a recess 52 positioned under the step area 50, for placement of the light emitting device 44. The recess 52 is a through hole from the lower surface 48 to the upper surface 46. Above the light emitting device 44 is a transparent plate 54 fixed at the upper surface 46 of the step board 42 and covered above the recess 52. The transparent plate 54 is used to protect the light emitting device 44 from damage resulting from the foot of the driver or other sources.

As shown in FIG. 2, the light emitting device 44 comprises a circuit board 56 and a plurality of light emitting diodes (LED) 58 installed on the circuit board 56 for emitting the light. The footpad 40 further comprises a control circuitry 60 electrically connected to the light emitting device 44 for controlling the light emitting device 44. The control circuitry 60 can be installed in the recess 52, on the circuit board 56, or any other place.

When the driver opens a door (not shown) of a vehicle (not shown) to which the footpad 40 is connected, the control circuitry 60 controls the light emitting device 44 to turn on and shine light upward through the recess 52 to illuminate the step area 50 of the footpad 40. Due to the illumination, the driver can readily spot a location of the footpad 40, and conveniently board the vehicle. Upon closing the door, the light emitting device 44 turns off. Though in this example, the control circuitry 60 controls the light emitting device 44 to turn on and turn off according to a state of openness of the door, it should be obvious to one skilled in the art that the control circuitry 60 could be programmed to respond in various ways to various conditions. Some possible conditions and responses are presence of heat indicating an approaching passenger causing the light emitting device 44 to turn on, or presence of sufficient light causing the light emitting device 44 not to turn on. For a case where the light emitting device 44 is a plurality of light emitting devices arranged in a grid, even more options are available. Upon receiving a signal from an electronic key opener, the control circuitry 60 may cause the light emitting device grid to display a message, such as “Welcome” or “Please step on me,” depending on a preference of the user.

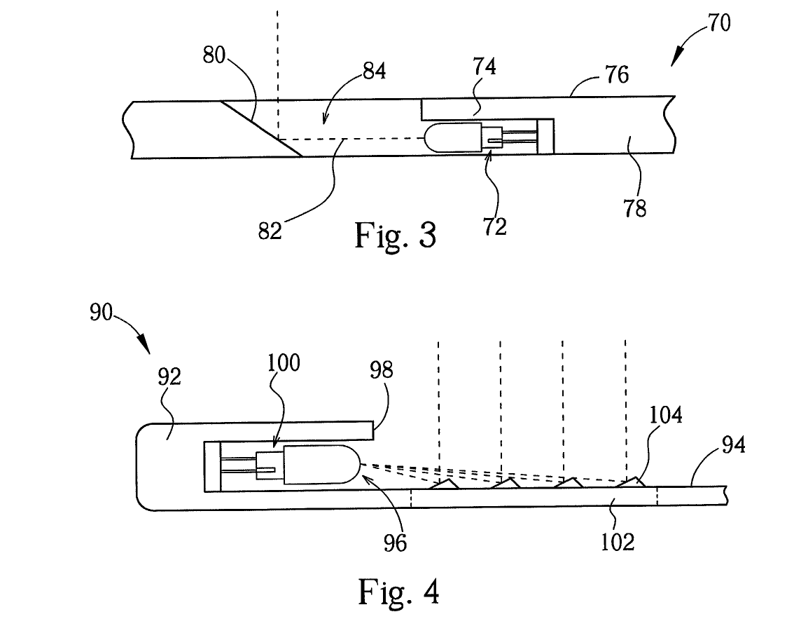

Please refer to FIG. 3, which illustrates a second embodiment footpad 70 of the present invention. In this second embodiment, a light emitting device 72 is set under a protrusion 74 of an upper surface 76 of a step board 78. The protrusion 74 is used to protect the light emitting device 72 from being directly stepped by a person. The footpad 70 further comprises an angled reflective surface 80 in a recess 84. Light (as indicated by the dashed line 82) is emitted from the light emitting device 72, and reflects off of the angled reflective surface 80 to shine at the driver, indicating the position of the footpad 70.

Please refer to FIG. 4, which is a diagram of yet a third embodiment footpad 90 of the present invention. The footpad 90 includes a vertical flange 92 installed at one side of an upper surface 94. The vertical flange 92 comprises a recess 96 on its vertical side 98 wherein a light emitting device 100 is installed in the recess 96 and protected by the vertical flange 92 from being touched by the person's foot. A step area 102 of the footpad 90 comprises a plurality of small protrusions 104 for reflecting the light. Again, as indicated by the dashed lines, light is emitted from the light emitting device 100, and reflects now off of the plurality of small protrusions 104 to indicate the position of the footpad 90.

The present invention boarding device, in using the light emitting device, improves visibility of the step area of the footpad, thereby reducing the risk of injury for the driver, and saving precious seconds when boarding the vehicle.

In addition, although the step board of the boarding device according the present invention is illustrated as a footpad in above embodiments, it can also be an accelerator pedal, a brake pedal or a clutch pedal of a motor vehicle. A person skilled in the art can easily apply this technique to the pedals after reading above disclosure.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A boarding device of a motor vehicle comprising:
a step board having a flat upper surface and a lower surface, the upper surface comprising a step area near its center portion for a foot of a person to step on, the lower surface comprising a recess positioned under the step area; and
a light emitting device installed in the recess for emitting light upward through the recess so that the person can see the step area before stepping on the step area.

2. The boarding device of claim 1 wherein the recess of the step board is a through hole from the lower surface to the upper surface.

3. The boarding device of claim 2 wherein the step board further comprises a transparent plate fixed at the upper surface of the step board and covered above the recess for protecting the light emitting device.

4. The boarding device of claim 1 wherein the light emitting device comprises a circuit board and a plurality of light emitting diodes (LED) installed on the circuit board for emitting the light.

5. The boarding device of claim 1 wherein the step board comprises an angled surface in the recess for reflecting the light from the light emitting device upward so that a person can see the step area through the reflected light from the angled surface of the recess.

6. The boarding device of claim 5 wherein the step board further comprises a protrusion in the recess above the light emitting device for protecting the light emitting device.

7. The boarding device of claim 1 wherein the motor vehicle is a car having at least one door frame and the step board is mounted under the door frame of the car for assisting the person to get into the car.

8. The boarding device of claim 7 wherein the car further comprises a door movably attached to the door frame and the light emitting device is turned on when the door is opened and is turned off when the door is closed.

9. A boarding device of a motor vehicle comprising:
a step board having a flat upper surface and a lower surface, the upper surface comprising a step area near its center portion for a foot of a person to step on; and
a light emitting device installed on one side of the step board for emitting light to the step area so that the person can see the step area from the light reflected from the step area.

10. The boarding device of claim 9 wherein the step board comprises a vertical flange installed at one side of the upper surface and the vertical flange comprises at least one recess on its vertical side wherein the light emitting device is installed in the recess and protected by the vertical flange from being touched by the person's foot.

11. The boarding device of claim 10 wherein the step area of the step board comprises a plurality of small protrusions for reflecting the light emitted from the light emitting device.

12. The boarding device of claim 9 wherein the light emitting device comprises a circuit board and a plurality of light emitting diodes (LED) installed on the circuit board for emitting the light.

13. The boarding device of claim 9 wherein the motor vehicle is a car having at least one door frame and the step board is mounted under the door frame of the car for assisting the person to get into the car.

14. The boarding device of claim 13 wherein the car further comprises a door movably attached to the door frame and the light emitting device is turned on when the door is opened and is turned off when the door is closed.

15. The boarding device of claim 9 wherein the step board can be an accelerator pedal, a brake pedal or a clutch pedal of the motor vehicle.
